(19) United States
(12) Patent Application Publication
(10) Pub. No.: US 2014/0207873 A1
(43) Pub. Date: Jul. 24, 2014

(54) Method and Apparatus for Crowd-Sourced Information Presentation

(71) Applicant: FORD GLOBAL TECHNOLOGIES, LLC, Dearborn, MI (US)

(72) Inventors: Jayanthi Rao, West Bloomfield, MI (US); Thomas J. Giuli, Mountain View, CA (US); Krishnaswamy Venkatesh Prasad, Ann Arbor, MI (US)

(73) Assignee: FORD GLOBAL TECHNOLOGIES, LLC, Dearborn, MI (US)

(21) Appl. No.: 13/744,612

(22) Filed: Jan. 18, 2013

(51) Int. Cl. H04L 12/58

(52) U.S. Cl. CPC H04L 12/58
USPC 709/206

(57) ABSTRACT

A system includes a processor configured to receive a request to provide email read-back. The processor is also configured to access contact information for at least one human email read-back party. Further, the processor is configured to determine the availability of the at least one party to read back one or more emails, using the contact information. Also, the processor is configured to deliver the one or more emails to the at least one party for read-back and receive audio data from the party corresponding to the delivered emails

### TECHNICAL FIELD

The illustrative embodiments generally relates to a method and apparatus for crowd-sourced information presentation.

### BACKGROUND

In the on-the-go modern world, where information is often available at the click of a button, certain expectations have arisen whereby people sending digital communications often want or desire near-instantaneous response. Unfortunately, a great deal of communication can be received by any given individual over the course of a day, and it is often difficult to find time to review all of the incoming communication.

In many instances, users may want to utilize “down time” to review digital communication, but sometimes cannot, due to the nature of the down time. For example, a driver with an hour long commute may often find themselves in a situation where there is little in the way of traffic and there is opportunity to consider incoming information (radio, CD, etc.). This might be an optimal time to clear out an inbox.

While digital solutions for email reading may be available, they often struggle with context and content, and cannot always deliver optimal results. U.S. Patent Application 2011/0121991 discusses a vehicle communication system including a plurality of user accounts, each user account corresponding to a user. A server is programmed to receive communication invitations from inviting vehicles, and is programmed to transmit the communication invitations to invitee vehicles to facilitate inter-vehicle communication.

Another communication delivery system is discussed in U.S. Application 2004/0254715, which generally relates to a car navigation device mounted in a vehicle is capable of notifying a driver of an email incoming. Here, information relating to a traveling speed of the vehicle is retrieved. Based on the retrieved information, when the traveling speed of the vehicle is greater than a predetermined speed, notifying the driver of the email incoming is prohibited. This decreases a risk when the driver is notified of the email incoming while driving the vehicle,

Utilizing available resources, there is a great deal of innovation that can be done to improve the ability of drivers to review incoming email and digital communications.

### SUMMARY

In a first illustrative embodiment, a system includes a processor configured to receive a request to provide email read-back. The processor is also configured to access contact information for at least one human email read-back party. Further, the processor is configured to determine the availability of the at least one party to read back one or more emails, using the contact information. Also, the processor is configured to deliver the one or more emails to the at least one party for read-back and receive audio data from the party corresponding to the delivered emails.

In a second illustrative embodiment, a computer-implemented method includes receiving a request to provide email read-back. The method also includes accessing contact information for at least one human email read-back party. Further, the method includes using the contact information, at a first computer, determining the availability of the at least one party to read back one or more emails. The method additionally includes delivering the one or more emails to the at least one party for read-back and receiving audio data from the party corresponding to the delivered emails.

In a third illustrative embodiment, a system includes a processor configured to select an email for read-back to a user. The processor is also configured to provide a user with one or more human parties suitable for reading back the selected email. The processor is further configured to receive selection of a party for email read-back and check availability of the selected party. The processor is also configured to provide an available, selected party with the email and output audio corresponding to received audio from the selected party reading back the email.

### BRIEF DESCRIPTION OF THE DRAWINGS

FIG. 1 shows an illustrative example of a vehicle computing system;

FIG. 2 shows an illustrative example of an email reading/processing process;

FIG. 3 shows an illustrative example of an email reading process;

FIG. 4 shows another illustrative example of an email reading process;

FIG. 5 shows an illustrative example of a reader determination process; and

FIG. 6 shows an illustrative example of an email reader confirmation process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

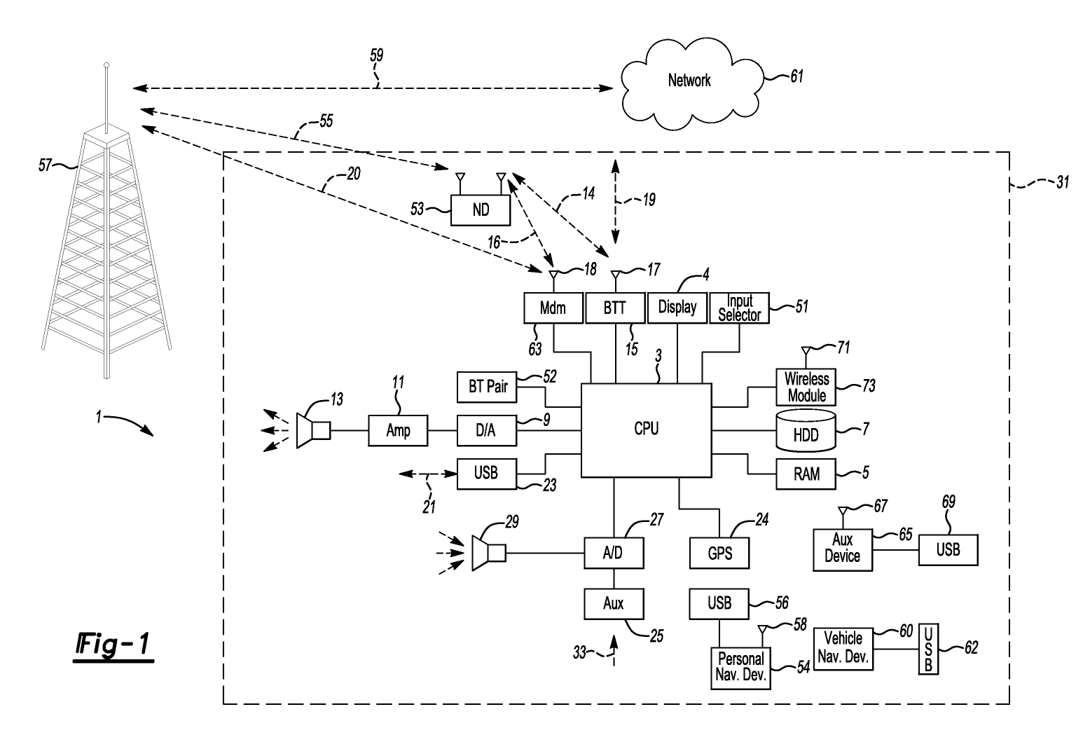

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Digital processes exist that are capable of translating text to voice based communication and utilizable for output of that information as audio files. In some cases, however, digital analysis may not be available or possible. In other instances, the driver may wish to have a human read an email in order to provide tone and context. Through the application of crowd-sourcing, the illustrative embodiments provide a system under which emails can be read by one human to another.

Context aware filtering can be utilize to limit the emails that are read to the driver. For example, emails may be filtered to only include those emails provided by friends and/or family, or, in another instance, emails that are relevant to a current journey (e.g., relating to upcoming meetings or sent by parties to upcoming meetings on a calendar).

The actual conversion itself can utilize cloud-based resources, such as, but not limited to people known to the driver (friends, family, secretary), strangers working for a “read-back” company, parties to an upcoming meeting to which an email relates, an email sender, etc. In cases where a stranger is reading an email, it may be desirable to use a double-blind conversion process to “scrub” user data from an email to preserve sensitive information as much as possible.

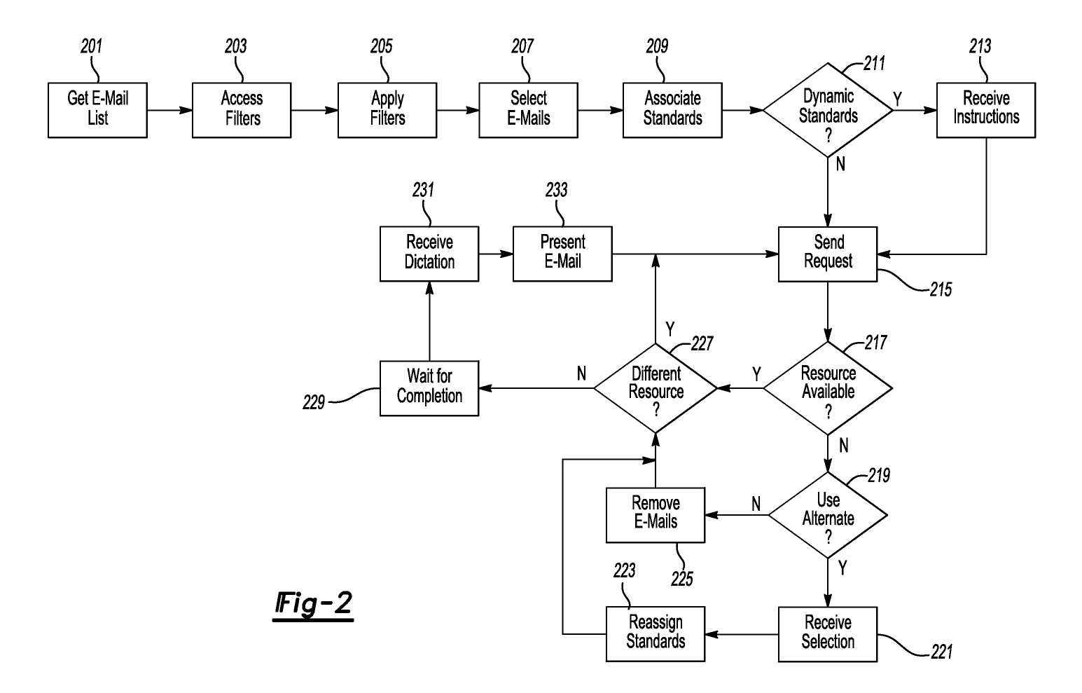

FIG. 2 shows an illustrative example of an email reading/processing process. In this illustrative example, an email converting process may run, for example, on a remote server in communication with a vehicle computing system. In this example, one or more filters may be applied in order to ensure that only relevant emails are read-back. This can, for example, restrict emails to currently relevant (e.g., business context) emails, personal emails from select senders, etc. These filters can be pre-set, user set, etc.

In this illustrative example, after a list of emails is obtained for playback 201, the process may access a database containing user filters. The filters could also be uploaded from a vehicle, or dynamically input by a user at the time a request was launched. For example, a user may state or input a request to have “business” emails read, “personal” emails read, “family” emails read, “friends” emails read, etc. Once the filters have been accessed 203, the process may apply the filters 205 to the list of emails in order to select certain emails for reading 207. These emails, in bulk or in packets of varying size, may be selected for transport to a reading party.

Next, in this embodiment, one or more “reader” standards may be associated with the emails to be read back to the user 209. These standards could be fixed or dynamic in nature. In other words, the user may always elect to use the same reader (or service), or particular readers for particular email types, or may elect to choose from a variety of reader types whenever a request is made.

If the standards are dynamic in nature 211 (i.e., the user will elect a particular type of reader), the user can instruct a certain type of standard to be associated with the email upon inception of the request 213. In another instance, the user can instruct a preference of read-back options in a particular order. For example, a user may typically have a secretary read back emails during a business day. But, if the secretary is not available, the user may choose to utilize a professional read-back service in order to complete review of an email, albeit with some likely cost.

Once a particular reader or group of readers has been selected for a given email, a request can be sent to that party 215 requesting email read-back. Since a variety of emails may be present, a number of requests may be sent simultaneously. For example, a user may elect to have a spouse read back personal emails, a secretary read back business emails, and a paid service to fill in if either is unavailable. In such a case, each party can be contacted with respect to one or more emails at the same time, based on filtering and application of the standards. If multiple responses (read back emails) come in at once, the read emails can be queued and delivered to the user in a manner specified by the user (or, for example, in the order received, etc.).

For each requested resource, the process may check to see if that resource is available 217. This could involve sending a request to a resource computer, sending a text message to a resource or placing an automated call to a resource, for example. In another example, resources could be logged into a system if available and the system may check a login log to see if a particular resource is logged in. If a particular resource is not available, the process may determine if an alternative to the resource should be used/tried 219.

If an alternative source is to be used, the user may either select (at that time) a new source, or, in another example, a new source may be selected based on a previous ordering of sources. Once the selection of a new source has been received or retrieved 221, the process may also check if this resource is different from the resource whose availability was initially checked 227. In the case where the first resource checked was available, this answer would be “yes” because the resources would correspond. If a secondary resource were selected, however, the process may have to send a request to this resource to see if it is available, and, if not, a tertiary resource may be selected, etc.

If the resource is available and is selected, the process may then wait to receive one or more incoming communiqués indicating completion of reading of one or more emails 229. In some cases, the emails may be presented as they are completed, in some cases (e.g., long emails) communication may begin after some portion of the email has been read, and in other cases (e.g., queuing of multiple sources, driver not present, etc.) an entire group of sent emails may be read. In the “driver not present” scenario, it may be the case that a request was entered and then the driver left a vehicle, or there is an “auto-read” status associated with an account and/or some email types. For example, if a driver has a 3-5 meeting and then intends to drive home, the driver may create a request that all emails meeting certain criteria (or all emails in general) be read during that time period. Then, when the driver enters the vehicle, the emails will be completed. In another scenario, certain “pay per read” based resources may offer discounts if no requests are pending, and a driver may opt to have emails read if a certain rate per read is available.

Once the appropriate completion has finished, the process receives the dictation corresponding to the read email(s) 231. This can be an audio file or could even be a phone call to the vehicle over which one or more emails is read. In other examples, the data can be transmitted over a wireless internet connection, voice over IP, etc. Once an appropriate amount of data has been received, playback of the read portion of the email can begin 233.

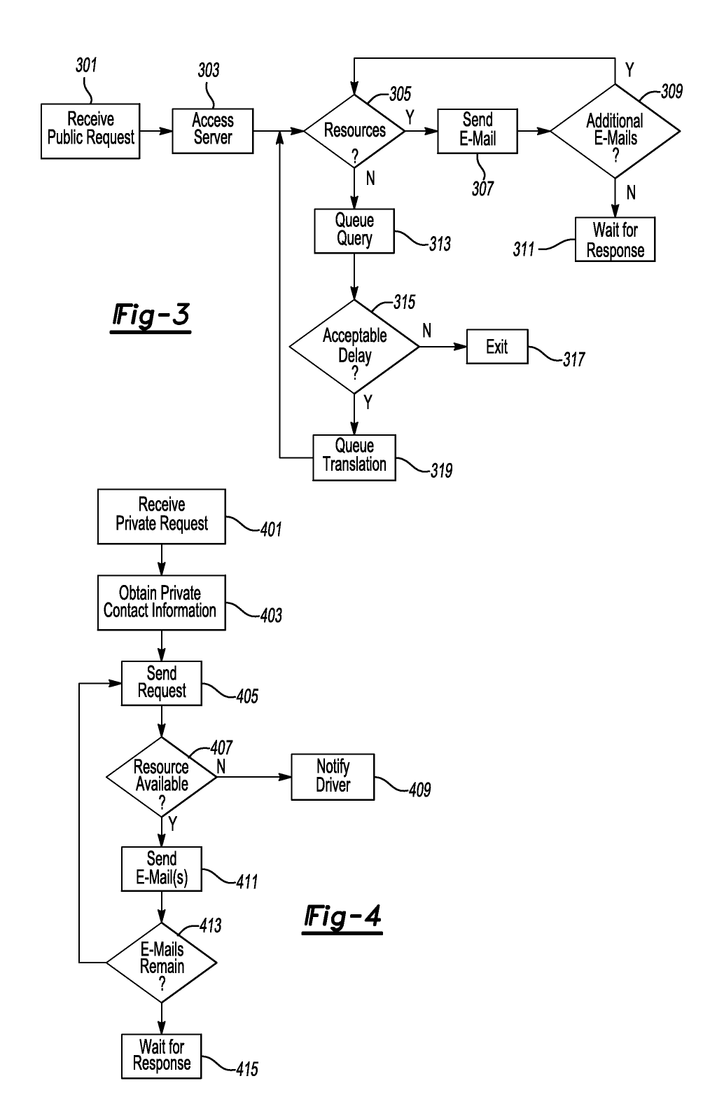

FIG. 3 shows an illustrative example of an email reading process. In this illustrative embodiment, there may be one or more services (e.g., “public”) that provide reading of emails as a cost-based service (or for other reasons). In such an example, the process receives a request to “publicly” read one or more emails 301. In this sense, “public” does not mean that the double blind privacy will not be enacted, the word simply means that the reader may not be a party known to the requestor.

Once the request has been received, the process will access a server associated with a public read-back service 303. This could be a server feeding emails to a plurality of services, or a server that is associated with a particular read-back service. Once the process has accessed the server, it checks to see if any read-back resources are available 305. This could be based on a price the user is willing to pay, or simply based on a “free agent” status of a read-back agent. If resources are available sufficient to handle some or all of a request, the process may send one or more emails to be read by the service 307. In this example, emails are sent one at a time, and if additional emails remain 309, the process may check for additional resources. For example, if there are 1,000 agents working for a service, and the customer has 20 emails to be read, it may be more efficient to have 20 available agents read one email each, if there happen to be that many available at the time. This can help optimize agent usage, although the actual strategy can be left up to a service provider. Once the appropriate number of emails has been sent to the service, the process may wait for one or more responses correlating to finished emails 311.

If there are insufficient resources for a particular request 305, the process may queue the request for completion when resources become available 313. In this example, there may be an estimated delay associated with the availability of resources 315. If the delay is acceptable to the requestor 315, the process may queue the request and wait for resources to become available 319, otherwise, the process may exit or try a different service or server.

FIG. 4 shows another illustrative example of an email reading process. In this example, a private request for email reading is received 401. In this sense, “private” refers to the fact that a reader is known by a user (e.g., without limitation, friend, family, secretary, colleague, business partner, etc.). As with the public request, the private reader may not be currently available when the request comes in. Accordingly, contact information for the private reader may be obtained 403. This could be an email address, a phone number, login information, etc.

Once contact information has been received, the process sends a request to the party 405 asking if the party is available to read one or more emails for the requestor. If the resource (party) is not available, the driver may be notified so a different party could be selected 409. In another instance, there may be a number of parties associated with a request, and the process may cycle through the parties until an available resource is found.

If the resource is available, the process may send one or more emails to that resource for read-back 411. As with the other requests, a number of emails may be sent to a number of resources simultaneously, in order to expedite read-back. Results that come in while other results are being played back can simply be queued for later delivery to the user. Once one or more emails has been sent to the resource, the process may check to see if any emails remain 413. If emails remain, the process may check the availability of the selected (or a different) resource to see if the additional emails can also be handled. Once the available number of resources has been put to use, the process can then wait for one or more responses to come in from the readers 415.

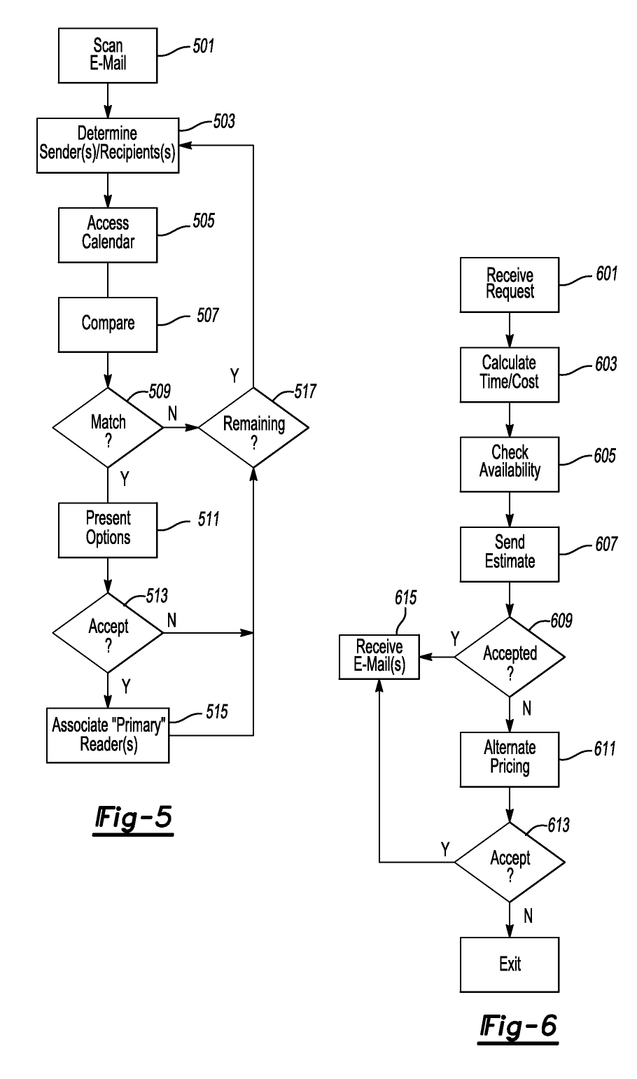

FIG. 5 shows an illustrative example of a reader determination process. In this illustrative embodiment, the process dynamically determines a number of readers to be associated with read-back of certain emails. It may be the case that emails from some parties are always read by a spouse, other emails may always be read by a secretary (e.g., emails from a work server) and in another case, the read-back of emails may be dynamically allocated based on parties associated with those emails. This is an instance of the allocation process.

In this example, the process scans one or more stored emails 501 to determine if there are any emails fitting the “dynamic reader” qualifications. In this case, readers will be determined based on, for example, senders and/or recipients, so in this example the process determines senders and recipients associated with the email 503. Also, although not necessary, in this example the process is designed to filter down the emails to those relevant to upcoming calendar appointments. For example, if a party is traveling in their car at 1 PM, they may have 20 emails in their inbox. Five may be personal, and readable by a spouse. Five may be irrelevant, five may be associated with a work-server (i.e., internal) and five may be from outside parties and qualify as possible candidates for “work emails”.

For each of those emails, the process may, following determination of a sender and/or recipients, access a user's calendar 505 to see if any senders or recipients are affiliated with any upcoming meetings (e.g., meetings between 1 PM and 5 PM on the specific calendar day). By comparing the senders and other recipients to the meeting members 507, the process can determine which, if any, of the emails might correlate to any of the upcoming meetings 509. If there isn't a match for a particular email, the process may check other emails 517.

If there is a match for a particular email, the process may present the driver with one or more options for parties from whom to request email read-back 511. For example, the process will likely skip the user, since that would not be a party who would read back the email. The process may also skip other recipients or senders based on saved or past known preferences. In this example, at least one possible read-back candidate will be presented 511 and the driver has the option to accept 513 or decline one or all of the recipients. If at least one recipient is accepted, the process can associate the accepted party(s) with the email and then contact one or more of those parties for requested read-back at an appropriate time.

FIG. 6 shows an illustrative example of an email reader confirmation process. In this example, the process is associated with a pay-per-read type of service, and may be executed on a service provider's server, for example. In this illustrative process, the process receives a request for one or more emails to be read back 601. Based on an email size/volume, the process may calculate a time and/or cost for email read-back 603.

In addition to calculating a time and cost, the process also checks to see what, if any, availability exists (which can help determine what portion of the email can be read back immediately) 605. Once the appropriate data is known, an estimate of the cost, time and availability can be sent to the user 607. The estimate can then be presented to the user and if accepted 609, the process will receive one or more emails to be read by the service 611.

If the estimate is not accepted, the process may present some alternative pricing scheme 611. For example, the user may be on their way to a long meeting, and may only want the emails read at some point in the day. While they may not be willing to pay to have the emails read immediately, they may be willing to pay to have the emails read at some point throughout the day. Accordingly, the server may offer a cheaper price for read-back at a later time, such as when there is an availability of agents. If the alternative pricing is accepted 613, the process again receives the corresponding emails 615.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request to provide email read-back;
access contact information for at least one human email read-back party;
using the contact information, determine availability of the at least one party to read back one or more emails;
deliver the one or more emails to the at least one party for read-back; and
receive audio data from the party corresponding to the delivered emails.

2. The system of claim 1, wherein the processor is further configured to deliver the audio data to a requesting party in a vehicle.

3. The system of claim 1, wherein the at least one party is a sender or recipient of at least one email.

4. The system of claim 1, wherein the at least one party is a friend or family member of a requesting party.

5. The system of claim 1, wherein the at least one party is an employee of a read-back service.

6. The system of claim 1, wherein the processor is configured to determine the availability of the at least one party by sending a text message to the at least one party.

7. The system of claim 1, wherein the processor is configured to determine the availability of the at least one party by sending an email message to the at least one party.

8. The system of claim 1, wherein the processor is configured to determine the availability of the at least one party by calling the at least one party.

9. The system of claim 1, wherein the processor is configured to send different emails to different parties for read-back based at least on a subject, sender, or content of each of the different emails.

10. A computer-implemented method comprising:
receiving a request to provide email read-back;
accessing contact information for at least one human email read-back party;
using the contact information, at a first computer, determining availability of the at least one party to read back one or more emails;
delivering the one or more emails to the at least one party for read-back; and
receiving audio data from the party corresponding to the delivered emails.

11. The method of claim 10, further comprising delivering the audio data to a requesting party in a vehicle.

12. The method of claim 10, wherein the at least one party is a sender or recipient of at least one email.

13. The method of claim 10, wherein the at least one party is a friend or family member of a requesting party.

14. The method of claim 10, wherein the at least one party is an employee of a read-back service.

15. The method of claim 10, further comprising determining the availability of the at least one party by sending a text message to the at least one party.

16. The method of claim 10, further comprising determining the availability of the at least one party by sending an email message to the at least one party.

17. The method of claim 10, further comprising determining the availability of the at least one party by calling the at least one party.

18. The method of claim 10, further comprising sending different emails to different parties for read-back based at least on a subject, sender, or content of each of the different emails.

19. A system comprising:
a processor configured to:
select an email for read-back to a user;
provide a user with one or more human parties suitable for reading back the selected email;
receive selection of a party for email read-back;
check availability of the selected party;
provide an available, selected party with the email; and
output audio corresponding to received audio from the selected party reading back the email.

20. The system of claim 19, wherein the processor is configured to select at least a first party automatically, and the user is provided with the one or more parties when an automatically selected party is unavailable.
